(19) United States
(12) Patent Application Publication
(10) Pub. No.: US 2006/0159282 A1
(43) Pub. Date: Jul. 20, 2006

(54) Method for suppressing electroacoustic feedback

(76) Inventor: Martin Borsch, Willich (DE)

Correspondence Address: QUARLES & BRADY LLP, 411 E. WISCONSIN AVENUE, SUITE 2040, MILWAUKEE, WI, 53202-4497, US

(21) Appl. No.: 11/052,398

(22) Filed: Feb. 7, 2005

(30) Foreign Application Priority Data
Jan. 19, 2005 (EP) EP 05001063

(51) Int. Cl. H04B 15/00; H04R 3/00

(52) U.S. Cl. 381/93; 381/83; 381/95

(57) ABSTRACT

A method for suppressing electroacoustic feedback in an audio system including a microphone that drives a loudspeaker system via an amplifier, in particular as part of a public address system, includes a) monitoring the level of the microphone signal on the microphone-amplifier path; b) determining the readiness for occurrence of feedback when the level of the microphone signal exceeds a threshold value; c) determining a critical frequency at which the level of the microphone signal exceeds the threshold value and interpreting this frequency as the feedback frequency; and d) filtering out the feedback frequency from the microphone signal to suppress the feedback; wherein the microphone signal is transformed from the time range to a frequency range by fast Fourier transform (FFT) before step a), and the frequency at which the maximum level of the microphone signal exceeds the threshold value in the form of a predetermined ratio of the maximum level of the microphone signal to the total level of the microphone signal is interpreted as the feedback frequency.

### CROSS REFERENCES TO RELATED APPLICATIONS

Not Applicable.

### STATEMENT REGARDING FEDERALLY SPONSORED RESEARCH

Not Applicable.

### BACKGROUND OF THE INVENTION

1. Field of the Invention

The invention relates to a method for suppressing electro-acoustic feedback in an audio system, comprising a microphone that drives a loudspeaker system via an amplifier, in particular as part of a public address (PA) system including a microphone that drives a loudspeaker system via an amplifier.

2. Description of the Prior Art

Electroacoustic performances, such as live music events, often use PA systems with microphones so that voices and instruments can be detected electroacoustically, amplified, and played back via loudspeakers. Feedback of the amplified microphone signal may occur over the microphone-amplifier path, producing a loud, unpleasant sound over the loudspeaker. Such feedback occurs in particular when the loudspeaker sound signal picked up by the microphone passes through the microphone-amplifier path in phase with the microphone effective signal. These signals may be ramped up progressively via the feedback loop, generating high and extremely high sound amplitudes through the loudspeaker with a typical feedback frequency which varies over a period of time.

According to a previous countermeasure with respect to feedback effects, the PA system is turned off or its amplification is at least drastically reduced. Alternatively, it is known that the range of the feedback frequency, inasmuch as it has been determined by experience, may be filtered out of the audio frequency band more or less broadband, but then this frequency range is missing in the playback.

An even more effective measure is a generic method in which the feedback frequency is determined and filtered out automatically. However, this method is not quick enough or accurate enough under all conditions of practical relevance, nor is it free of negative impact on playback quality, and thus there is a demand for a method for suppressing electroacoustic feedback in an audio system including a microphone that drives a loudspeaker system via an amplifier, such that the occurrence of feedback effects is prevented rapidly and reliably without negatively impacting playback quality.

### SUMMARY OF THE INVENTION

The object of this invention is to create a method for suppressing electroacoustic feedback in an audio system that effectively suppresses feedback effects without negatively impacting the playback quality of the audio system. This object is achieved by a) monitoring the level of the microphone signal on the microphone-amplifier path; b) determining the readiness for the occurrence of feedback when the level of the microphone signal exceeds a threshold value; c) determining a critical frequency at which the level of the microphone signal exceeds the threshold value and interpreting this frequency as the feedback frequency; and d) filtering the feedback frequency out of the microphone signal to suppress the feedback; wherein, before step a), the microphone signal is transformed from the time range to a frequency range by a fast Fourier transform (FFT), and the frequency at which the maximum level of the microphone signal exceeds the threshold value in the form of a predetermined ratio of the maximum level of the microphone signal to the total level of the microphone signal is interpreted as the feedback frequency.

According to the basic idea of this invention, a) monitoring the level of the microphone signal on the microphone-amplifier path; b) determining the readiness for the occurrence of feedback when the level of the microphone signal exceeds a threshold value; c) determining a critical frequency at which the level of the microphone signal exceeds the threshold value and interpreting this frequency as the feedback frequency; and d) filtering the feedback frequency out of the microphone signal to suppress the feedback, according to the state of the art, runs in the time range and occurs in the frequency range in which the microphone signal is converted by a fast Fourier transform. In this case, the feedback frequency is interpreted according to this invention as the frequency at which the maximum level of the microphone signal exceeds the threshold value in the form of a predetermined ratio of the maximum level of the microphone signal in relation to the total level of the microphone signal.

It is proposed that in order to optimize the accuracy in the detection of the feedback frequency, in the inventive method the microphone signal is transformed from the time range to a Bark-scaled frequency range by all-pass filtering in combination with fast Fourier transform (FFT) before performing the steps of the generic method. The feedback frequency is preferably filtered out as a narrow band, in particular by using a notch filter, which can be implemented with a band width of 1/60 of an octave and does not negatively impact the effective audio signal through its use according to this invention. In order to be able to accurately determine signs of feedback at this high rate of detection as well as the feedback frequency and the level which occurs there, correction procedures involving the frequency and level are proposed according to this invention, which can be implemented in realtime without any time loss.

The maximum microphone level is subjected to an error correction referencing to two adjacent lower levels of lower and/or higher frequency. The feedback frequency is preferably subjected to an error correction referencing two adjacent frequencies with a lower microphone level than the maximum level. The value of the feedback frequency is preferably subjected to a correction by replacing it with a value obtained by linear interpolation from two adjacent frequency values.

In addition, the signal level at the feedback frequency is subjected to a correction in relation to an adjacent signal level. The correction is preferably performed in relation to the adjacent signal level of two adjacent signal levels whose value is closest to the signal level at the feedback frequency.

In summary, the following advantages can be achieved with the inventive method:

a) Feedback can be detected and counteracted very quickly, especially through the use of a fast Fourier transform (FFT).

b) Feedback can be detected and counteracted with precision, especially through the use of a network of all-pass filters for converting the FFT to a Bark-scaled frequency range.

c) The audio signal, i.e., the microphone signal is virtually unimpaired by the use of very narrow-band filters for suppression of feedback.

d) By correcting the filter frequency of the narrow-band filter, it is possible to instantly track any migration of the feedback frequency.

e) Finally, according to this invention, the narrow-band filter for filtering out the feedback frequency is to be corrected when it changes over a period of time. In this way, the narrow-band approach of filtering can also be retained even when there is a change in feedback frequency without having to accept the disadvantages of increased broadband filtering for this case.

The foregoing and other objectives and advantages of the invention will appear from the following description. In the description, reference is made to the accompanying drawings which form a part hereof, and in which there is shown by way of illustration a preferred embodiment of the invention. Such embodiment does not necessarily represent the full scope of the invention, however, and reference is made therefore to the claims herein for interpreting the scope of the invention.

### BRIEF DESCRIPTION OF THE DRAWINGS

FIG. 1 shows schematically a PA audio system to illustrate the development of a feedback loop;

FIG. 2 shows the filter curve of a notch filter having a band width of 1/60 of an octave;

FIG. 3 is a schematic representation of the working method of a frequency correction procedure, using a frequency/level diagram; and

FIG. 4 is a schematic representation of a level correction procedure.

### DETAILED DESCRIPTION OF THE PREFERRED EMBODIMENTS

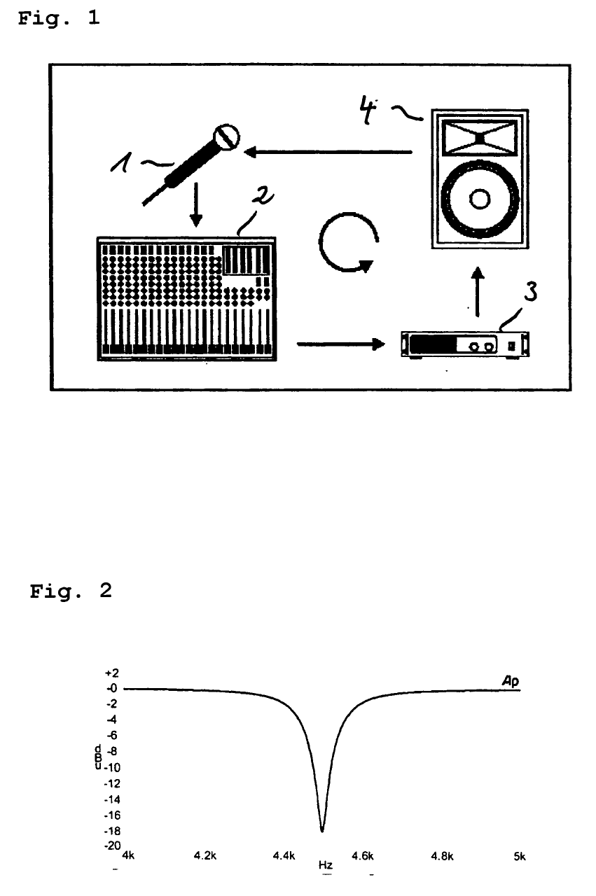

FIG. 1 shows a PA system which is typically used for live events and includes a microphone 1 whose microphone signal is fed into a power amplifier 3 via a mixing console 2 which drives a loudspeaker 4 with the amplified microphone signal. In this system, a feedback loop occurs when the sound emitted by the loudspeaker is captured by the microphone 1 and is supplied to the amplifier in phase with the useful signal of the microphone, which is used by an instrumentalist or a vocalist, for example, and is then emitted by the loudspeaker. This loop is indicated with a circular arrow in FIG. 1.

According to this invention, the development of feedback in the feedback loop is suppressed by detecting the level of the microphone signal on the microphone-amplifier path, whereby the readiness for the occurrence of feedback is detected in that the level of the microphone signal exceeds a threshold value. The frequency of the microphone signal at this critical level is evaluated as a feedback frequency and, for the purpose of suppressing feedback, is filtered out of the microphone signal by means of a narrow-band filter such as the notch filter, whose frequency characteristic is illustrated in FIG. 2.

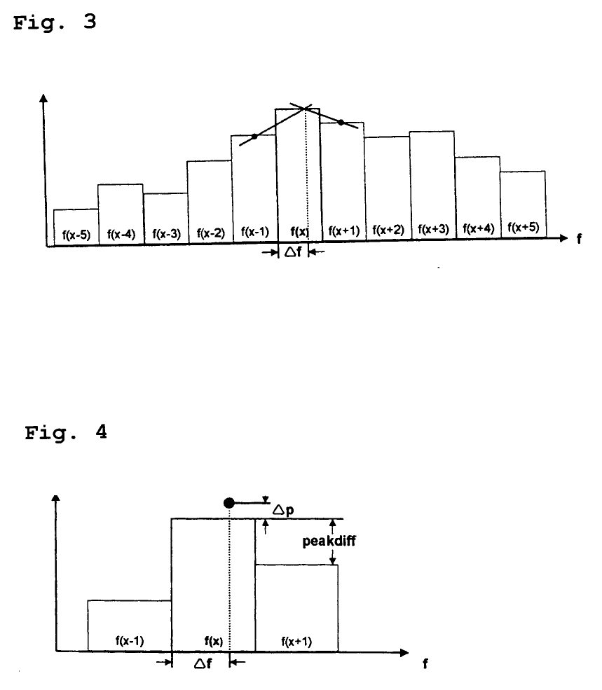

To be able to determine the feedback frequency rapidly and accurately, the microphone signal is transformed from the time range to the frequency range by a combination of a network of all-pass filters and a fast Fourier transform (FFT). This combination, which corresponds to a warped FFT, results in a Bark-scaled frequency spectrum which closely approximates a logarithmic scaling. In this frequency spectrum, the maximum level is determined and subjected to an error correction by means of two adjacent frequency values (FIG. 3). As soon as this level reaches a predetermined ratio of the total level of the microphone signal (a resulting defined threshold value), the frequency at which this level occurs is interpreted, i.e., defined as the feedback frequency and is filtered out of the frequency spectrum by means of a narrow-band filter. If necessary, a filter that already exists near this frequency can be shifted to the position of this frequency and rendered effective there.

FIG. 3 shows the measured energy of a few frequency pots. The exact feedback frequency is determined with the help of linear interpolation as illustrated by two straight lines in FIG. 3. Two frequency values adjacent to the feedback frequency are provided with a pitch (+/−). This results in the interpolated position of the frequency with maximum energy at the point of intersection of the two straight lines:
Δf=k+[3·f(x+1)+f(x−1)]/[f(x−1)+f(x+1)].

The correction of the maximum level is performed in agreement with FIG. 4 based on a tabulated correction value k which runs anti-proportional to the value of the difference “peakdiff” of the maximum level at the frequency f(x) to the adjacent level at the frequency f(x+1). The lower the difference (“peakdiff”), the greater is the factor k and thus also the level correction value Δp=k (peakdiff).

When the determined change in feedback frequency at a specific time is relatively minor as a function of time, the filter frequency of the notch filter (FIG. 2) is preferably appropriately tracked without intermission.

While there has been shown and described what is at present considered the preferred embodiment of the invention, it will be obvious to those skilled in the art that various changes and modifications can be made therein without departing from the scope of the invention defined by the appended claims.

1. A method for suppressing electroacoustic feedback in an audio system comprising a microphone that drives a loudspeaker system via an amplifier, in particular as part of a public address system, including the steps:
a) monitoring the level of the microphone signal on the microphone-amplifier path;
b) determining the readiness for the occurrence of feedback when the level of the microphone signal exceeds a threshold value;
c) determining a critical frequency at which the level of the microphone signal exceeds the threshold value and interpreting this frequency as the feedback frequency; and
d) filtering the feedback frequency out of the microphone signal to suppress the feedback;
characterized in that before step a), the microphone signal is transformed from the time range to a frequency range by a fast Fourier transform (FFT), and the frequency at which the maximum level of the microphone signal exceeds the threshold value in the form of a predetermined ratio of the maximum level of the microphone signal to the total level of the microphone signal is interpreted as the feedback frequency.

2. The method according to claim 2, characterized in that before step a), the microphone signal is transformed from the time range to a Bark-scaled frequency range by all-pass filtering in combination with the fast Fourier transform (FFT).

3. The method according to claim 1, characterized in that the maximum microphone level is subjected to an error correction referencing two adjacent lower levels of a lower or higher frequency.

4. The method according to claim 1, characterized in that the feedback frequency is subjected to an error correction by referencing two adjacent frequencies with a lower microphone signal level than the maximum level.

5. The method according to claim 1, characterized in that the value of the feedback frequency is subjected to a correction in relation to adjacent frequency values.

6. The method according to claim 5, characterized in that the value of the feedback frequency is subjected to a correction by replacing it with a value obtained by linear interpolation from two adjacent frequency values.

7. The method according to claim 6, characterized in that a straight line of the same slope is drawn through the two adjacent frequency values, where the point of intersection determines the value of the critical frequency.

8. The method according to claim 1, characterized in that the signal level at the feedback frequency is subjected to a correction in relation to an adjacent signal level.

9. The method according to claim 8, characterized in that the correction is performed in relation to the adjacent signal level of two adjacent signal levels whose value is closest to the signal level at the feedback frequency.

10. The method according to claim 8, characterized in that the signal level at the feedback frequency is subjected to a correction by adding the level difference to the adjacent level multiplied by a correction value which is anti-proportional to the level difference and is preferably stored in the form of tables.

11. The method according to claim 1, characterized in that the feedback frequency is filtered out in a narrow band by a filter to suppress feedback from the microphone signal.

12. The method according to claim 11, characterized in that the narrow-band filter is a notch filter.

13. The method according to claim 11, characterized in that the narrow-band filter of the critical frequency is corrected when it changes over time.
